(19) United States
(12) Patent Application Publication
(10) Pub. No.: US 2010/0024011 A1
(43) Pub. Date: Jan. 28, 2010

(54) DOCUMENT MANAGEMENT SYSTEM AND DOCUMENT MANAGEMENT METHOD

(75) Inventor: Fumihiro Fukuoka, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/507,690

(22) Filed: Jul. 22, 2009

(30) Foreign Application Priority Data
Jul. 28, 2008 (JP) 2008-193825

(51) Int. Cl. H04L 9/32

(52) U.S. Cl. 726/5

(57) ABSTRACT

When a valid password is input by a user having a right to access a folder, a decrypted document and image for view are produced from an encrypted document included in the folder and stored in the folder such that they are correlated with the encrypted document. If a request to view a document in this folder is issued by a user having a right to access the folder, a corresponding image for view is displayed on a terminal of the issuer of the request. When a request to acquire a document in the folder in order to save it is issued, a corresponding encrypted document is transmitted to a terminal of the issuer of the request. In a case where a request to acquire a document in the folder in order to print it is issued, a corresponding decrypted document is transmitted to an terminal of the issuer of the request.

### BACKGROUND OF THE INVENTION

1. Field of the Invention

The present invention relates to a document management system, a document management method, and a computer program, and more particularly to a document management system, a document management method, and a computer program capable of managing document data in an encrypted form.

2. Description of the Related Art

Many document management systems using WWW (World Wide Web)-based application software are available. In such a document management system, documents are generally dealt with using a WWW browser running on a personal computer (PC). In most of such document management systems, it is capable of directly transmitting an electronic document from a scanner or a digital multifunction peripheral to an information processing apparatus via a network and registering the electronic document in the information processing apparatus. This makes it possible to convert paper documents in an office into an electronic form and manage the documents in the electronic form. This capability leads to an increase in need for the document management system.

In the document management system, rights of users (or groups of users) to access documents (access rights) are managed in units of folders or documents thereby controlling access to documents. To register a document such that the document is shared by a plurality of users, the document is registered in a special folder and access right to this folder is given to the plurality of users. Any user having the right to access this folder in which the document is register is allowed to access (and download) any document registered in this folder. Thus, one of the users having the right to access the folder in which the document is registered can copy the document to a file system different from a file system to which the folder belongs or to a document management system different from the document management system to which the folder belongs. This can cause the copied document to be transferred to a user having no right to access the original folder (document management system) in which the document was originally registered. Thus a possibility occurs that the data is accessed or transferred by or to an unauthorized user.

A widely employed method to avoid the above problem is to assign a password to a document according to an input given by a user and encrypt it using the password thereby ensuring the security of the document. For this purpose, PDF (Portable Document Format) may be used not only as software for use on a personal computer but also as a file format that allows a document to be represented in an electronic form protected with a password.

However, when a large number of documents protected with passwords are registered in folders corresponding to different access rights, it becomes very troublesome for produces of documents to manage passwords. It is necessary to send passwords to all users having rights to access or view documents. For users who need documents only for viewing or printing, it is very troublesome to input keywords whenever documents are viewed or printed. Besides, sending passwords can create a risk that leakage of passwords can cause documents to be accessed by unauthorized users.

One technique to avoid the above problem is to automatically generate a password assigned to a document when the document is registered. When a request to view or acquire the document is issued from a terminal having an access right, the document is decrypted using the generated password (see, for example, Japanese Patent Laid-Open No. 2003-242035). This technique makes it unnecessary for a user to input the password as long as the request to view or acquire the document is issued from the terminal having the access right.

However, when the above-described technique disclosed in Japanese Patent Laid-Open No. 2003-242035 is applied to a system in which access rights are managed in units of folders or documents, following problems can occur. In the technique disclosed in Japanese Patent Laid-Open No. 2003-242035, access rights are set in units of terminals. If a document is moved or copied into a folder assigned an access right different from an access right assigned to an original folder in which the document was originally located, there can be a possibility that the document is accessed by a user unintended by producer of the document. Another problem is that if an access right is changed after the document is registered, there can be a possibility that the document can be accessed by a user who has newly obtained an access right regardless of the intention of the producer of the document.

### SUMMARY OF THE INVENTION

The present invention provides a document management apparatus and document management method that allow a user having a right to access a document without having to input a password even in a state in which access rights are set in units of folders or documents.

According to an aspect of the present invention, there is provided a document management system configured to manage encrypted document data encrypted using a password, comprising a storage unit configured to store the encrypted document data and decrypted document data obtained by decrypting the encrypted document data in a correlated manner in a storage area, and a return unit configured to return document data such that when a request for access to document data stored in the storage area is issued by a user having a right to access the document data or the storage area in which the document data is stored, the return unit returns decrypted document data corresponding to the document data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating an example of a configuration of a document reading system according to an embodiment of the present invention.

FIG. 2 is a diagram illustrating an example of an internal configuration of an information processing apparatus disposed in a document management system according to an embodiment of the present invention.

FIG. 3 is a block diagram illustrating an example of a functional configuration of a document management system according to an embodiment of the present invention.

FIG. 4 is a diagram illustrating an example of a main document management window according to an embodiment of the present invention.

FIG. 5 is a diagram illustrating an example of a document password input window according to an embodiment of the present invention.

FIG. 6 is a diagram illustrating an example of a main document management window displayed in a state in which a document has been subjected to decryption, according to an embodiment of the present invention.

FIG. 7 is a diagram illustrating an example of an image-for-view display window according to an embodiment of the present invention.

FIG. 8 is a flow chart illustrating an example of a process performed by a document management system in response to receiving a request to decrypt encrypted PDF document data according to an embodiment of the present invention.

FIG. 9 is a flow chart illustrating an example of a process performed by a document management system in response to receiving a request to view or acquire PDF document data according to an embodiment of the present invention.

FIG. 10 is a diagram illustrating an example of a state in terms of rights to access folders according to an embodiment of the present invention.

FIG. 11 is a diagram illustrating an example of a main document management window displayed when a document is copied or moved according to an embodiment of the present invention.

FIG. 12 is a diagram illustrating an example of a destination folder selection window for selecting a folder to which to move a document according to an embodiment of the present invention.

FIG. 13 is a diagram illustrating an example of a main document management window in a state in which a document has been moved in accordance with an instruction issued by a producer of the document according to an embodiment of the present invention.

FIG. 14 is a diagram illustrating an example of a main document management window in a state in which a document has been moved in accordance with an instruction issued by a user different from a producer of the document according to an embodiment of the present invention.

FIG. 15 is a flow chart illustrating an example of a process performed by a document management system in response to receiving a request to copy or move a PDF document according to an embodiment of the present invention.

FIG. 16 is a diagram illustrating an example of a window for changing a right to access folder according to an embodiment of the present invention.

FIG. 17 is a diagram illustrating an example of mail sent to a user who is a producer of PDF document data according to an embodiment of the present invention.

FIG. 18 is a diagram illustrating an example of an access right approval window according to an embodiment of the present invention.

FIG. 19 is a flow chart illustrating an example of a process performed by a document management system to change a right to access a folder according to an embodiment of the present invention.

FIG. 20 is a flow chart illustrating an example of a process performed by a document management system to give an access right depending on a new situation according to an embodiment of the present invention.

FIG. 21 is a flow chart illustrating an example of a process performed by a document management system in response to receiving a request to register a document according to an embodiment of the present invention.

### DESCRIPTION OF THE EMBODIMENTS

Preferred embodiments of the present invention will now be described in detail in accordance with the accompanying drawings.

### First Embodiment

A first embodiment of the present invention is described below with reference to accompanying drawings.

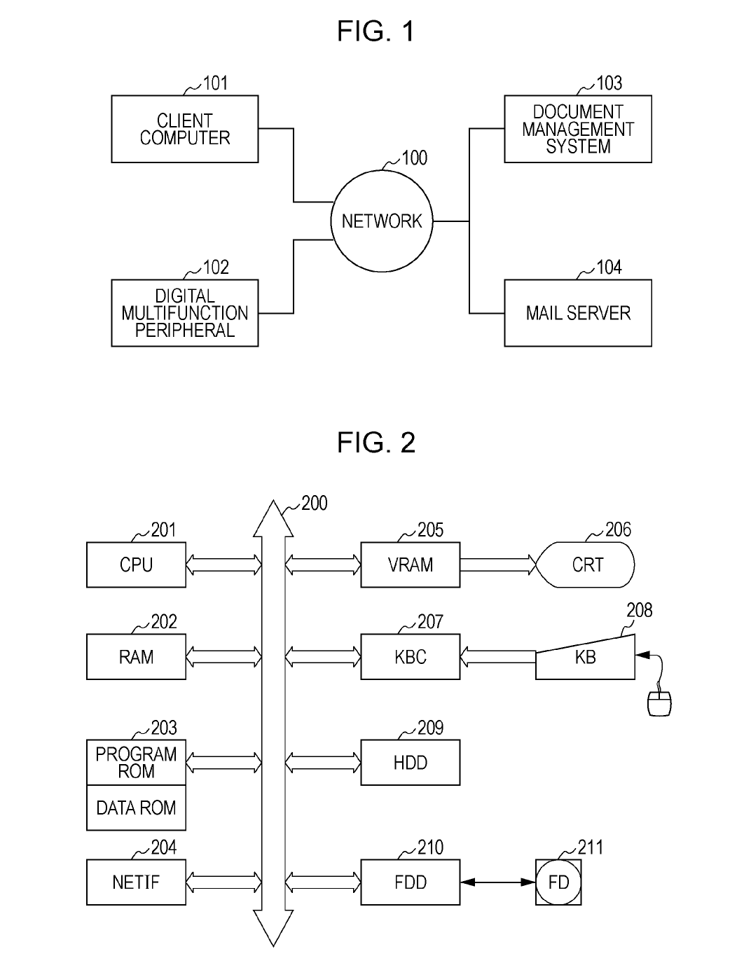

FIG. 1 illustrates an example of a configuration of a document reading system.

As shown in FIG. 1, the document reading system includes a client computer 101, a digital multifunction peripheral 102, a document management system 103, and a mail server 104. The client computer 101, the digital multifunction peripheral 102, the document management system 103, and the mail server 104 are connected to each other via a network 100 such as the Internet or a LAN (Local Area Network).

The client computer 101 is a personal computer (PC) or the like used by a user, and thus hereinafter the client computer 101 will also be referred to as the PC 101. A Web browser for accessing a Web server is installed in the PC 101. The Web browser may be of a widely used type. The PC 101 is capable of controlling an operation of the document management system 103 by accessing the document management system 103 via the Web browser.

In the following explanation of the present embodiment, by way of example, it is assumed that the Web browser is used by PC 101 to access document management system 103. Note that the accessing may be performed in a different manner. For example, client application software for exclusive use in accessing the document management system 103 may be installed in the PC 101, and accessing to the document management system 103 may be performed using this client application software.

The digital multifunction peripheral 102 is a device having a plurality of functions so as to operate as a copier, scanner, printer, facsimile machine, data transmitter, etc. The digital multifunction peripheral 102 is capable of connecting to the network 100 to transmit electronic data (document data), obtained as a result of processing including scanning a paper document and further image conversion, to a server or the document management system 103. In the following description, by way of example, the present embodiment will be explained for a case in which electronic data in the PDF (Portable Document Format) format is given as document data. Hereinafter, electronic data in the PDF format will also be referred to simply as PDF document data.

The digital multifunction peripheral 102 is capable of assigning a password to PDF document data during a scanning operation. The digital multifunction peripheral 102 is also capable of encrypting PDF document data. As with the PC 101, the digital multifunction peripheral 102 also has a Web browser installed therein for accessing a Web server. When the digital multifunction peripheral 102 downloads a PDF file via the Web browser, the digital multifunction peripheral 102 is capable directly printing the downloaded file.

The detailed configuration of the digital multifunction peripheral 102 is not essential to the present invention, and thus a further description thereof is omitted.

A user transmits data to the document management system 103 by using the scanning function and the data transmission function of the digital multifunction peripheral 102. In the present example, it is assumed that encrypted PDF is selected as a file format for data obtained via the scanning. More specifically, PDF document data is encrypted using a password input by a user and resultant data is transmitted to the document management system 103. Hereinafter, PDF document data encrypted in the above-described manner will be referred to simply as encrypted PDF document data.

The digital multifunction peripheral 102 transmits the PDF document data to a folder of the document management system 103. Together with the electronic data (encrypted PDF document data), the digital multifunction peripheral 102 also transmits data indicating a host name of the document management system 103, a folder path specified by a user, a user ID and a password necessary in accessing the document management system 103.

The document management system 103 includes one or a plurality of information processing apparatuses. Each information processing apparatus is configured to store and manage an information resource such as a folder or a document produced and registered by a user.

The mail server 104 is configured to transmit mail to a specified mail address in response to a request from a processing module in the document management system 103. In the present embodiment, by way of example, the mail server 104 is disposed separately from the document management system 103, although the document management system 103 may be configured to have the function of the mail server 104.

FIG. 2 illustrates an example of an internal configuration of an information processing apparatus disposed in the document management system 103.

A central processing unit (CPU) 201 is responsible for calculation and control of the information processing apparatus. A random access memory (RAM) 202 functions as a main memory used by the CPU 201. The RAM 202 also functions as a storage area of an execution program, an execution area of the execution program, and a data area of the execution program.

In a read only memory (ROM) 203, a procedure of an operation of the CPU 201 is stored. The ROM 203 includes a program ROM and a data ROM. In the program ROM, a system program (operating system (OS)), which is basic software for controlling the information processing apparatus, is stored. In the data ROM, information necessary in the operation of the system is stored. Instead of the ROM 203, an HDD 209 (described below) may be used.

A network interface (NETIF) 204 is configured to control transferring of data to an external apparatus via the network 100. The network interface (NETIF) 204 has a capability of performing a diagnostic connection test in terms of the connection between the information processing apparatus and the network 100. A video RAM (VRAM) 205 is configured to store data of an image to be displayed on a screen of a CRT 206 (described below). The image displayed on the CRT 206 is controlled by the data stored in the VRAM 205.

A display (a CRT in this specific example) 206 is a device configured to display information such as that indicating the operation status of the information processing apparatus. A keyboard controller (KBC) 207 is a controller that controls inputting of a signal via a keyboard (KB) 208 (described below). An external input device 208 is a device operated by a user. For example, a keyboard or a pointing device such as a mouse is used as the external input device 208. In the present embodiment, by way of example, a keyboard (KB) is used as the external input device 208.

A hard disk drive (HDD) 209 is for storing application programs and various kinds of data. In the present embodiment, the application programs are software programs to realize respective processing units according to the present embodiment.

An external input/output device (an FDD in the present example) 210 is a device configured to input/output data from/to a removable storage medium (an FD disk in the present example) 211. The removable storage medium is a data storage medium capable of storing data which is accessible by the external input/output device 210. The removable medium 211 may be a magnetic storage medium such as a flexible disk (FD disk), an optical storage medium such as a CD-ROM disk, an magneto-optical storage medium such as an MO-disk, a semiconductor storage medium such as a memory card, etc. The external input/output device 210 may be configured differently depending on the type of the removable storage medium 211 used.

An application program and/or data may be read from the FD 211 via the FDD 210 and may be stored on the HDD 209.

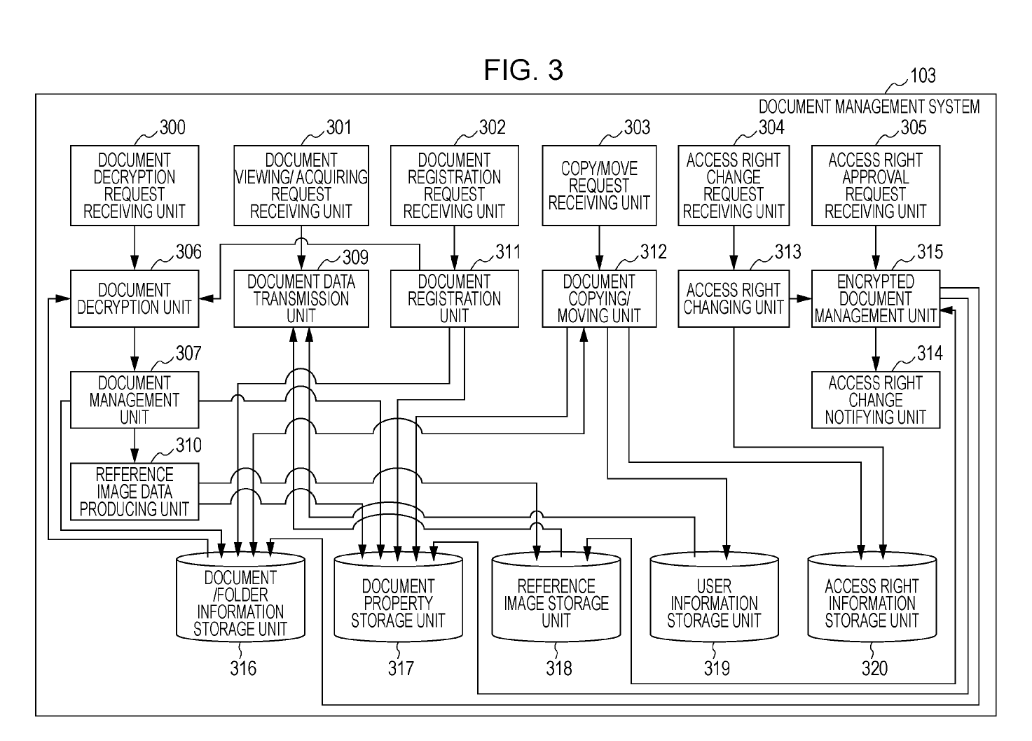

FIG. 3 is a block diagram illustrating an example of a functional configuration of the document management system 103. In other words, the information processing apparatus in the document management system 103 is configured to have functions shown in FIG. 3. Note that the functions shown in FIG. 3 may be divided into a plurality of information processing apparatuses disposed in the document management system 103.

The document management system 103 includes a plurality of processing units and a plurality of information storage units. The document management system 103 is configured to be capable of managing cabinets, folders, documents, and versions in a hierarchical manner although a further detailed explanation thereof is omitted. In the following explanation of the present embodiment, it is assumed that cabinets, folders, and documents have been stored in the document management system 103 and user information indicating users allowed to access the cabinets, folders, and documents has already been registered in the document management system 103.

Processing units 300 to 315 are configured to perform processing in accordance with a request issued by the PC 101 or the digital multifunction peripheral 102. Information storage units 316 to 320 are used by the processing units 300 to 315 to write/read information.

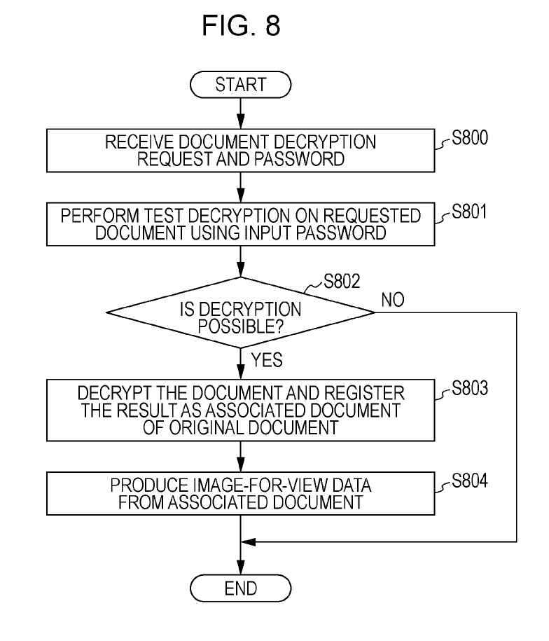

The functions of the processing units 300 to 315 and the functions of the information storage units 316 to 320 will be described in detail later with reference to flow charts shown in FIGS. 8, 9, 10, 15, 19, and 20.

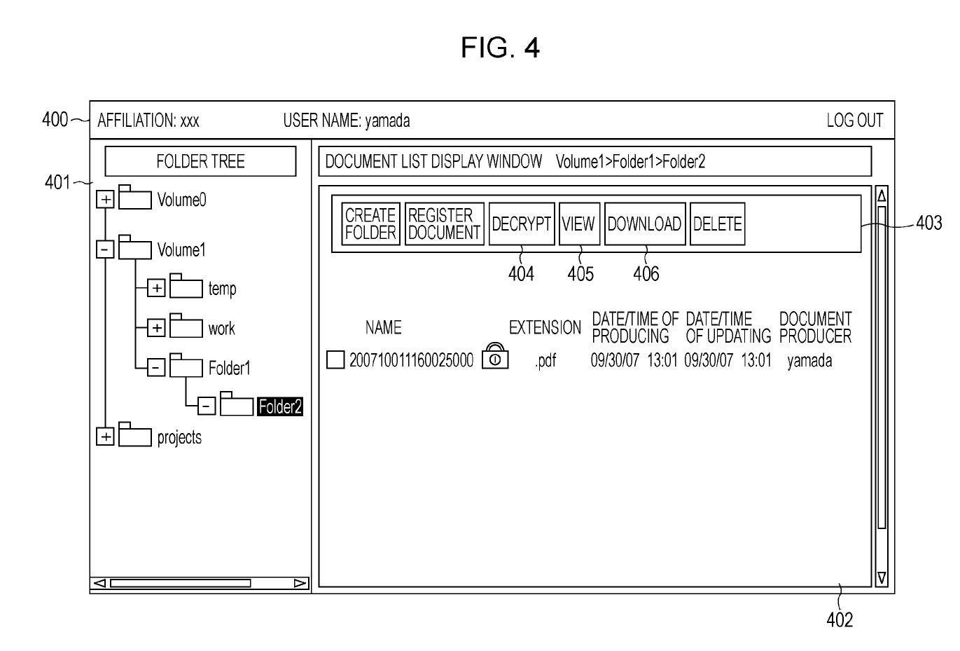

FIG. 4 illustrates an example of a main document management window.

A main document management window 400 is displayed on a display of the PC 101 when the PC 101 is connected to the document management system 103 and logs on thereto.

In FIG. 4, a folder tree displaying area 401 is a screen area for displaying folders managed in a hierarchically manner by the document management system 103. If a symbol + or a symbol − in this folder tree displaying area 401 is clicked by a user, a corresponding folder is opened or closed. If a folder displayed in the folder tree displaying area 401 is selected by a user, sub folders or a list of documents located in the selected folder are displayed in a document list displaying area 402.

In the example shown in FIG. 4, one document in encrypted PDF format (encrypted PDF document data) is registered in a folder #2. In the document list displaying area 402, an icon displayed to the right of a document name indicates that this particular document in the folder #2 is in the encrypted form. A user can easily distinguish whether a document is encrypted or not depending on whether such an icon is displayed or not. Note that tools other than icons may be used for the above purpose. For example, a document property may be displayed in a character string or the like to indicate whether a document is encrypted or not. Another way is to display the document name in a different color depending on whether the document is encrypted or not.

The document list displaying area 402 is a screen area for displaying a list of information associated with a folder selected by a user from folders displayed in the folder tree displaying areas 401. This document list displaying area 402 is mainly used by a user to specify a process to be performed on a folder or document selected. For example, a user is allowed to issue a command to create a sub folder. It is also allowed to issue a command to register, delete, or download a document. More specifically, to issue a command, a user clicks one of buttons in an operation button box 403. In the present example, a DECRYPT button 404 and VIEW button 405 are disposed in the operation button box 403 so that when one of these buttons is clicked, encrypted document data is decrypted or an image-for-view thereof is displayed.

After encrypted PDF document data is selected, if a DOWNLOAD button 406 in the operation button box 403 is clicked, the selected encrypted PDF document data is downloaded and stored in the PC 101.

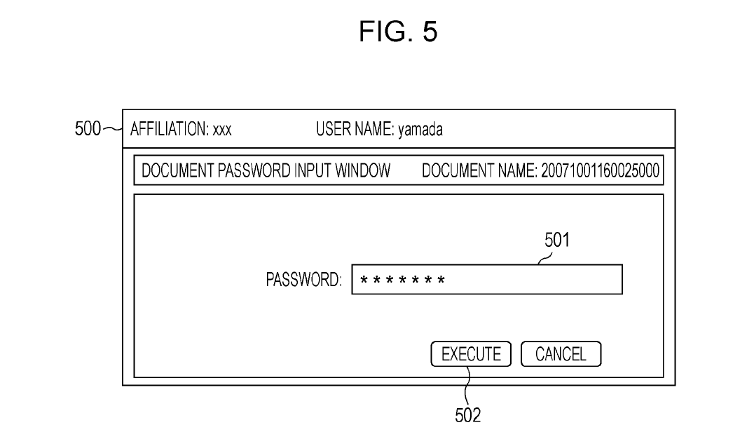

If a user (yamada in this example) selects an encrypted PDF document “20071001160025000” registered by him/her and then clicks the DECRYPT button 404, then a document password input window shown in FIG. 5 is displayed on a screen of a display of the PC 101. If the user who is operating the document password input window is different from the producer of the PDF document, an error message or the like may be displayed on the screen of the display of the PC 101 so that only the producer of the encrypted PDF document data is allowed to perform the operation to decrypt the document.

FIG. 5 illustrates an example of a document password input window 500 operated by a user to decrypt encrypted PDF document data specified by the user.

More specifically, the user may input the same password in a password input box 501 as that used when the document was produced and may further click an EXECUTE button 502.

If the EXECUTE button 502 is clicked by the user, information is transmitted to the document management system 103 from the Web browser running on the PC 101. The information transmitted to the document management system 103 includes a document decrypt request for decrypting a PDF document specified by the user, an identifier identifying the PDF document (encrypted PDF document data) specified by the user, an identifier identifying the user, and a password.

In the document management system 103, the decrypting of the encrypted PDF document data specified by the user and producing of image-for-view data are performed by a document decryption request receiving unit 300, a document decryption unit 306, and an image-for-view data producing unit 310. In the present embodiment, in the above-described processing, both encrypted data and decrypted data are managed in association with the same document data.

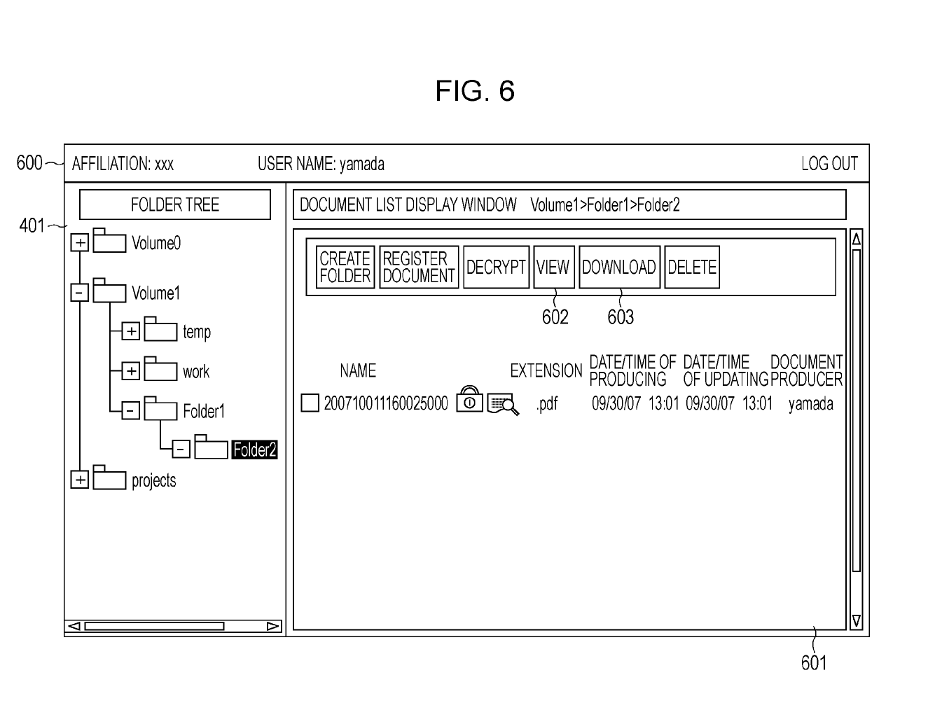

FIG. 6 illustrates an example of a main document management window which is displayed after decrypting of a document is completed. As can be seen in the example shown in FIG. 6, both encrypted PDF document data and decrypted PDF document obtained by decrypting the encrypted PDF document data are managed by the document management system 103. In a document list displaying area 601, an icon is displayed at a rightmost position in a name field to indicate that a document obtained by decrypting encrypted PDF document data is available for reading/viewing. A user can easily distinguish whether a document obtained by decrypting encrypted PDF document data is available for reading/viewing depending on whether such an icon is displayed or not, although tools other than icons may be used for this purpose. For example, a document property may be displayed in a character string or the like to indicate whether a decrypted version of the document for reading/viewing is available. Another way is to display the document name in a different color depending on whether a decrypted version of the document for reading/viewing is available.

If a user has a right to access a folder (folder #2 in the present example) selected in the document list displaying area 601, the user is allowed to read/view an image for view corresponding to the PDF document without having to input a password. That is, if the user clicks a VIEW button 602, the image for view corresponding to the PDF document is displayed on the screen of the display of the PC 101.

After a PDF document is selected, if a user clicks the DOWNLOAD button 603 in the document list displaying area 601, a file of the PDF document data selected by the user is downloaded into the PC 101. However, the file stored (downloaded) in the PC 101 is in an encrypted form (that is, encrypted PDF document data is stored).

In a case where a file of PDF document data for the purpose of printing is downloaded from the document management system 103 to the digital multifunction peripheral 102 via the Web browser installed on the digital multifunction peripheral 102, a decrypted file (decrypted PDF document data) is downloaded. Therefore, the digital multifunction peripheral 102 can directly print the downloaded document.

On the other hand, in a case where a document is downloaded to store the document in a storage device in the digital multifunction peripheral 102, an encrypted file (encrypted PDF document data) is downloaded as in the case where an encrypted file is downloaded in the PC 101.

In the document list displaying area 601, after PDF document data is selected by a user, if a VIEW button 602 is clicked by the user, then an image-for-view display window 700 is displayed on the screen of the display of the PC 101.

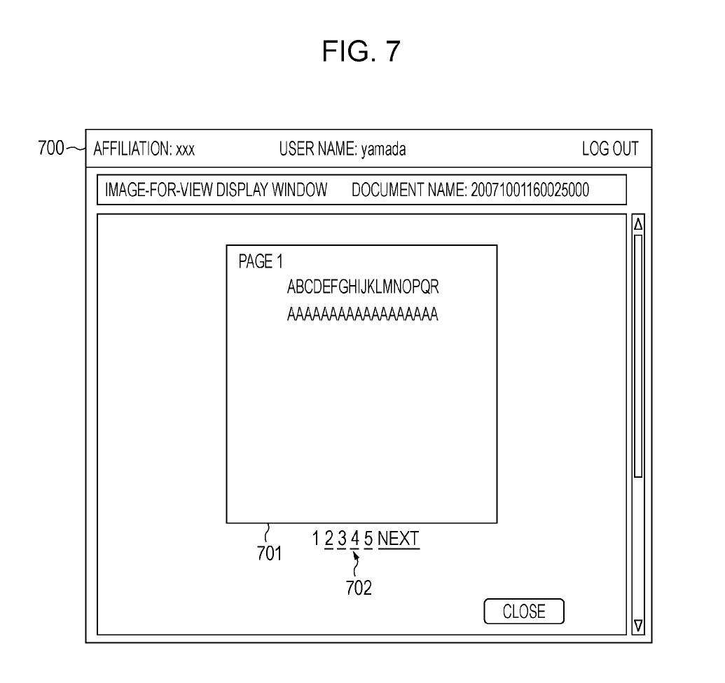

FIG. 7 illustrates an example of an image-for-view display window.

In the image-for-view display window 700 shown in FIG. 7, an image for view is displayed in an image display area 701 on a page-by-page basis. When the image for view of the PDF document includes a plurality of pages, if a page number displayed in a jump-to-page part 702 is clicked by a user, the image displayed in the image display area 701 jumps to a specified page.

The operation on the main document management window 600 shown in FIG. 6 and the image-for-view display window 700 shown in FIG. 7 is allowed not only by a user who registered the PDF document data but also by other users having a right to access the folder in which the PDF document data is stored. In other words, a user who produced and registered PDF document data permits this PDF document data to be decrypted by users having the right to access the folder in which the PDF document data is stored. Users having the right to access the PDF document data are allowed to view the PDF document data without having to input a password. On the other hand, users having no right to access the PDF document data are not allowed to view the PDF document data unless a valid password is input.

FIG. 8 is a flow chart illustrating an example of a process performed by the document management system 103 in response to receiving a request to decrypt encrypted PDF document data. Before reaching the document password input window 500 shown in FIG. 5, a user is assumed to have logged on the document management system 103 and have selected a document in the main document management window 400 shown in FIG. 4. It is also assumed that the identifier of the user and the identifier of the document data are stored in the RAM 202 of the document management system 103.

In this state, if the user inputs the password in the document password input window 500 shown in FIG. 5 and further clicks the EXECUTE button 502, then the Web browser of the PC 101 sends a document decrypt request to the document management system 103 together with the password, the identifier of the PDF document data, and the identifier of the user.

In step S800 in FIG. 8, the document decryption request receiving unit 300 in the document management system 103 receives the document decrypt request, the password, the identifier of the PDF document data, and the identifier of the user.

Next, in step S801, the document decryption request receiving unit 300 detects the password, the identifier of the PDF document data, and the identifier of the user from the data received in step S800, and puts these detected data in the RAM 201. The document decryption request receiving unit 300 then transfers the process to the document decryption unit 306. Based on the identifier of the PDF document data and the password, the document decryption unit 306 reads the encrypted PDF document data from the document/folder information storage unit 316 and performs a test decryption process on the read encrypted PDF document data.

In step S802, the document decryption unit 306 determines whether it is possible to decrypt the encrypted PDF document data read from the document/folder information storage unit 316. If it is determined that it is impossible to decrypt the encrypted PDF document data, the process of the flow chart shown in FIG. 8 is ended.

On the other hand, if it is determined that it is possible to decrypt the encrypted PDF document data, the processing flow proceeds to step S803. In step S803, according to the identifier of the PDF document data and the password stored in the RAM 202, document decryption unit 306 reads encrypted PDF document data from the document/folder information storage unit 316 and decrypts the encrypted PDF document data. The document management unit 307 stores the resultant decrypted PDF document data as an associated document of the original encrypted PDF document data in the document/folder information storage unit 316. Furthermore, the document management unit 307 describes property information in the document property storage unit 317 to indicate that the decrypted PDF document data is also available in addition to the encrypted PDF document data. Via the above process performed by the document management unit 307, the encrypted PDF document data and the decrypted PDF document data obtained by decrypting the encrypted PDF document data are correlated to each other. The document management unit 307 then transfers the process to the image-for-view data producing unit 310.

Thus, in the present embodiment, as described above, an example of encrypted document data is realized by encrypted PDF document data, and an example of decrypted document data is realized by decrypted PDF document data. Furthermore, an example of a storage unit is implemented by step S803.

Next, in step S804, the image-for-view data producing unit 310 reads decrypted PDF document data from the document/folder information storage unit 316 using the identifier of the PDF document data stored in the RAM as a search key, and the image-for-view data producing unit 310 produces image-for-view data. The image-for-view data producing unit 310 stores the produced image-for-view data in the image-for-view storage unit 318 and property information of the image-for-view data in the document property storage unit 317. In the present embodiment, the image-for-view data is correlated by the property information of the image-for-view data to the encrypted PDF document data and the decrypted PDF document data.

Thus, in the present embodiment, as described above, an example of image data is realized by image-for-view data, and an example of a storage unit and an example of a producing unit are implemented by step S804.

The decryption of encrypted PDF document data may be performed using a known technique, and thus a further detailed explanation thereof is omitted. In the present example, the process is described for a case in which one piece of encrypted PDF document data is decrypted. Note that a plurality of documented may be decrypted at a time.

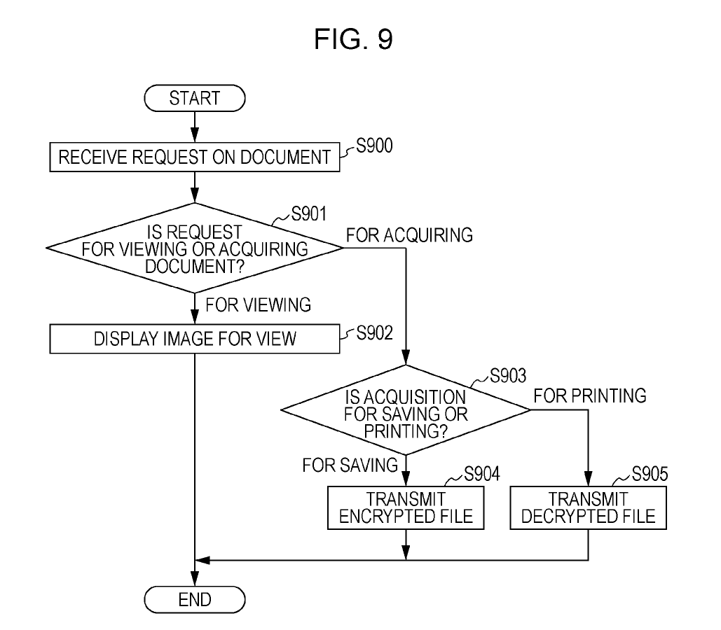

FIG. 9 is a flow chart illustrating an example of a process performed by the document management system 103 in response to receiving a request to view or acquire PDF document data.

In the main document management window 600 shown in FIG. 6, if a user selects a document and then clicks the VIEW button 602 or the DOWNLOAD button 603, the Web browser of the PC 101 or the Web browser of the digital multifunction peripheral 102 transmits a document view/acquisition request to the document management system 103.

In step S900 in FIG. 9, a document view/acquisition request receiving unit 301 in the document management system 103 receives the document view/acquisition request. The document view/acquisition request receiving unit 301 detects an identifier of PDF document data and detects details of a process to be performed from the received data, and writes them in the RAM 202.

Next, in step S901, the document view/acquisition request receiving unit 301 determines, based on the data indicating the details of the process to be performed on the PDF document data written in the RAM 202, whether the request is to view or acquire the PDF document data. If it is determined that viewing is requested, the processing flow proceeds to step S902. On the other hand, if it is determined that acquiring is requested, the processing flow proceeds to step S903.

In the case where the processing flow proceeds to step S902, a document data transmission unit 309 acquires image-for-view data from the image-for-view storage unit 318 in accordance with the PDF document data identifier stored in the RAM 202. The document data transmission unit 309 transmits the image-for-view data of each page of the PDF document to the Web browser of the PC 101. The PC 101 displays the image for view on the screen of the display in accordance with the image-for-view data received from the document management system 103.

On the other hand, in the case where the processing flow proceeds to step S903, the document view/acquisition request receiving unit 301 determines whether the purpose of the acquisition request issued by the PC 101 or the digital multifunction peripheral 102 is to store the document or print the document. This determination may be performed, for example, based on the data stored in the RAM 202 indicating the details of the process to be performed on the PDF document data.

If it is determined that the purpose of the document acquisition request is to store the document in the PC 101 or the digital multifunction peripheral 102, the processing flow proceeds to step S904. On the other hand, if it is determined that the purpose of the document acquisition request is to print the document by the digital multifunction peripheral 102, the processing flow proceeds to step S905.

In the case where the processing flow proceeds to step S904, in accordance with the identifier, stored in the RAM 202, of the PDF document data, the document data transmission unit 309 reads the encrypted PDF document data (PDF document) from the document/folder information storage unit 316. The document data transmission unit 309 transmits the encrypted PDF document data to the requester (the PC 101 or the digital multifunction peripheral 102). The PC 101 stores the received encrypted PDF document data in the storage unit disposed in the PC 101.

On the other hand, in the case where the processing flow proceeds to step S905, in accordance with the identifier, stored in the RAM 202, of the PDF document data, the document data transmission unit 309 reads the decrypted PDF document data (PDF document) from the document/folder information storage unit 316 and the document data transmission unit 309 transmits it to the digital multifunction peripheral 102. The digital multifunction peripheral 102 performs printing using the received decrypted PDF document data (PDF document).

Thus, in the present embodiment, as described above, an example of a determination unit is implemented by steps S901 and S903, and an example of a return unit is implemented by steps S902, S904, and S905.

Although in the example described above, only one document is acquired at a time, a plurality of documents may be acquired (downloaded) at a time.

In the example described above, after a document is registered in a folder by a user who is a producer of the document, a request to view, print, or acquire the PDF document data is issued by a user having a right to access this folder. However, as a result of an operation performed in the document management system 103 according to an instruction of a user, PDF document data can be copied or moved from a folder in which the PDF document was originally registered to a folder which is set differently from the original folder in terms of access rights. Hereinafter, this case will be referred to as a first case. Another possibility is that access rights to the original folder are changed, and, as a result, a greater number of users come to have a right to access the PDF document data. Hereinafter this case will be referred to as a second case.

The process performed in the document management system 103 is described further for the first and second cases.

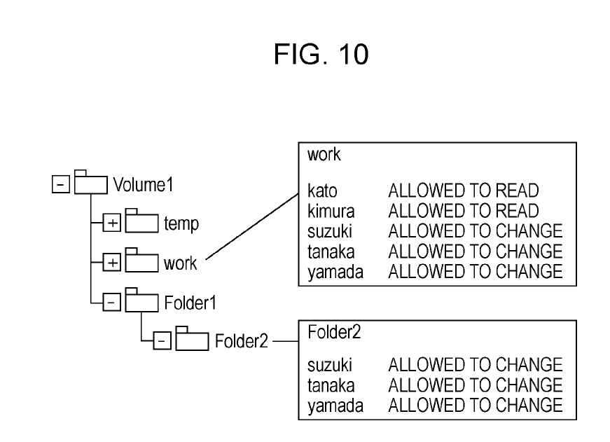

FIG. 10 illustrates an example of a status in terms of rights to access folders.

In the example described above with reference to FIGS. 4 and 6, a PDF document is registered in a folder (folder #2) by a user (yamada). As shown in FIG. 10, the folder #2 is allowed to be accessed by two other users in addition to the above-described user (yamada). In the present example, it is assumed that the PDF document is to be copied or moved from the folder #2 to a folder “work” that is allowed to be accessed by five users.

As can be seen from FIG. 10, two other users (suzuki and tanaka) in addition to yamada have a right to access both folders “work” and “folder #2”, and thus they are allowed to copy or move PDF document data from the folder “folder #2” to the folder “work”. After PDF document data is registered in the folder “folder #2” by the producer (yamada) of the document, if the PDF document data is copied or moved to another folder such as the folder “work”, then the copying or moving of the PDF document can bring the PDF document into a state in which the PDF document is allowed to be accessed by other users in addition to the users originally having the right to access this PDF document. Besides, if the right to access the folder “folder #2” is changed by a user other than the producer (yamada), there is a possibility that the PDF document is brought into a state in which the PDF document is allowed to be accessed without inputting a password by a user who is not intended by the producer (yamada).

In the present embodiment, to avoid the above problems, when a user other than a producer of PDF document data issues a request to copy or move the PDF document data from a source folder to a destination folder that is set differently in terms of access right from the source folder, only encrypted PDF document is copied or moved. In a case where the access right to a folder is changed such that a greater number of users have the right to access the folder without having to input a password, this fact is notified to the producer of the PDF document. In this case, until the producer of the PDF document permits the increase in the number of users allowed to access the folder without having to input passwords, acquisition of decrypted PDF document and viewing of image-for-view data are prohibited for any user except for the producer of the PDF document.

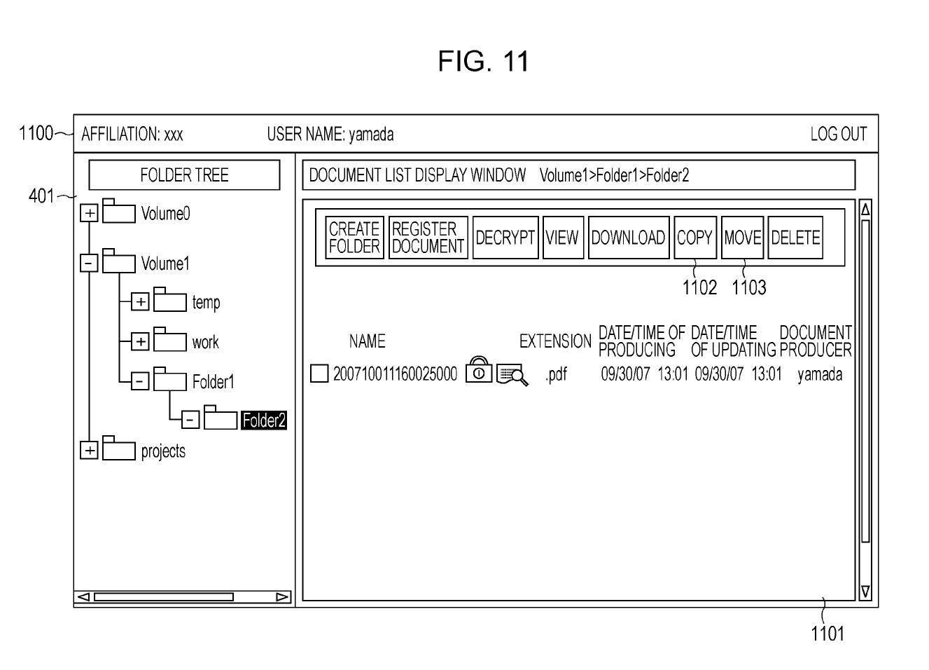

FIG. 11 illustrates an example of a main document management window displayed when a document is copied or moved.

The document list displaying area 1101 has a COPY button 1102 and a MOVE button 1103. The COPY button 1102 is clicked by a user to copy PDF document data selected by the user. The MOVE button 1103 is clicked by a user to move PDF document data selected by the user. In the following explanation, by way of example, it is assumed that the user (yamada) performs an operation to move PDF document to the folder “work”.

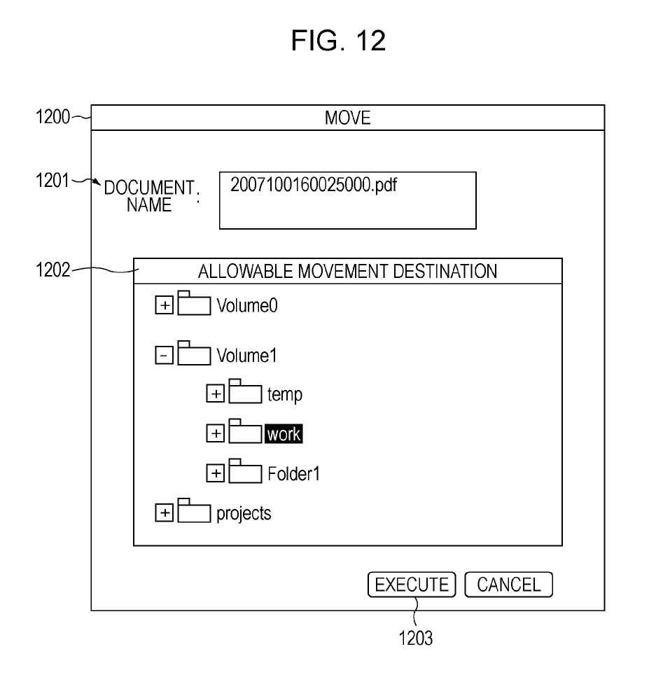

In the document list displaying area 1101, the user “yamada” selects PDF document data and clicks the MOVE button 1103. In response, the display screen of the PC 101 changes from the main document management window 1100 to a destination folder selection window 1200 shown in FIG. 12.

FIG. 12 illustrates an example of a destination folder selection window for selecting a folder to which to move a document.

In a destination folder selection area 1202, if a user (“yamada” in this example) selects a folder (the folder “work” in this example) and further clicks an EXECUTE button 1203, then processing is performed to move encrypted document data, decrypted document data, and image-for-view data corresponding to the PDF document data selected in the main document management window 1100. As a result of the process of moving the data, the data is deleted from the source folder (“folder #2”) and the data is stored in the destination folder (“work”).

In this case, after the moving of the PDF document data is performed in accordance with the command issued by the producer (yamada) of the PDF document data, the PDF document data in the folder “work” can be accessed without having to input a password by users having a right to access the folder “work”.

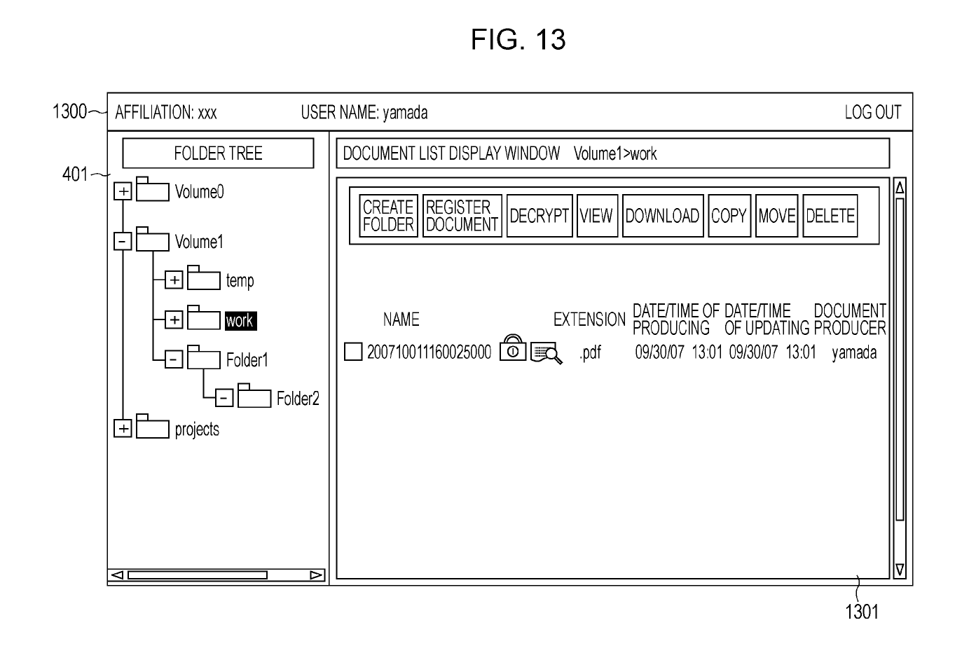

FIG. 13 illustrates an example of a main document management window displayed after a document has been moved in accordance with an instruction issued by a producer (“yamada” in this example) of the document.

In the example shown in FIG. 13, the main document management window 1300 indicates that a folder (folder “work” in this example) is selected and a document (20071001160025000) has been moved therein in such a manner that the document is allowed to be viewed.

Next, a process performed in a different situation is discussed below. Referring back to the main document management window 1100 shown in FIG. 11, if a user “suzuki” logs on and issues a command to move PDF document data to the folder “work” in this main document management window 1100, then, in this case, only encrypted PDF document data is moved to the folder “work”, because the user “suzuki” is not the producer of the PDF document data.

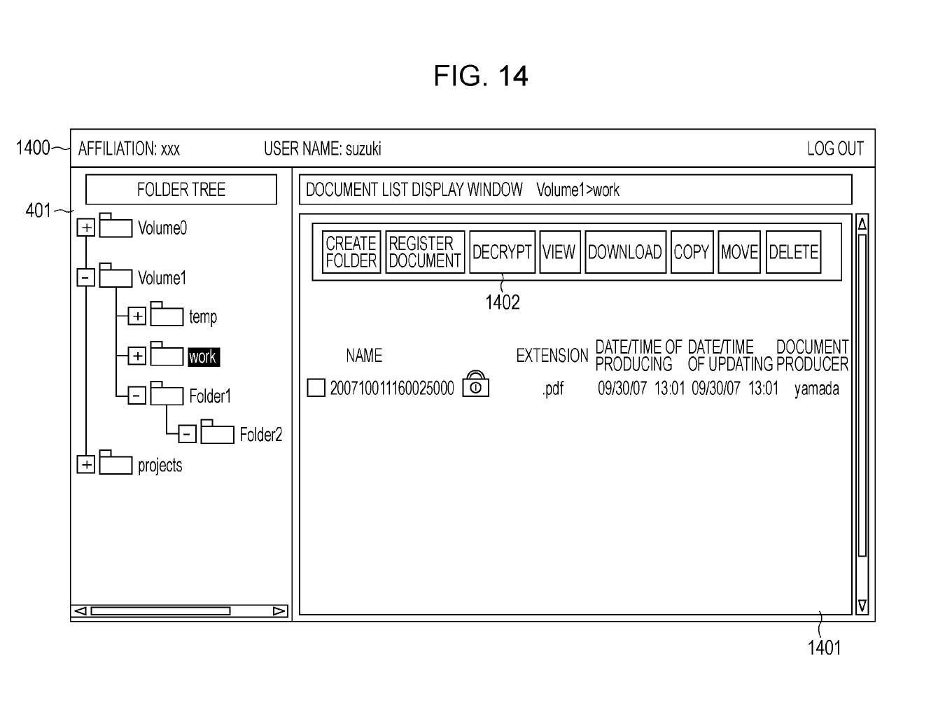

FIG. 14 illustrates an example of a main document management window displayed after a document has been moved in accordance with a command issued by a user different from a producer of the document.

In the main document management window 1400 shown in FIG. 14, as with the main document management window 1300 shown in FIG. 13, the folder “work” is in a selected state. However, the difference is in that the PDF document data moved into the folder “work” is in an encrypted form. In this case, therefore, when a user having a right to access the folder “work” wants to access this PDF document data, it is necessary to input a password assigned to this PDF document data.

Note that in the case where the user logging on the main document management window 1400 shown in FIG. 14 is producer (“yamada” in this example) of the PDF document data, the user is allowed to decrypt the PDF document data as described above with reference to FIGS. 4 and 5.

Note that although the original document in the source folder (“folder #2”) is deleted in the document moving process, the original document is not deleted in the copying process. Except for the difference described above, the copying process is similar to the moving process described above, and thus a further detailed explanation of the copying process is omitted.

A specific example of the copying/moving process performed in the document management system 103 is described in detail below with reference to flow charts.

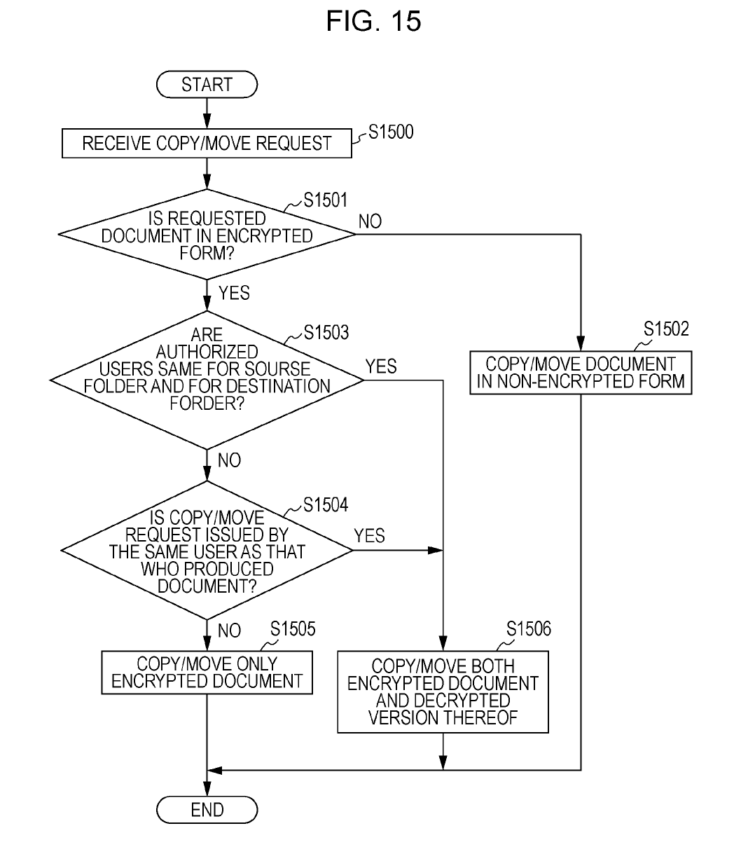

FIG. 15 is a flow chart illustrating an example of a process performed by the document management system 103 in response to receiving a request to copy or move a PDF document.

Referring again to the destination folder selection window 1200 show in FIG. 12, when a user selects a destination folder to which to copy or move PDF document data and the user then clicks the EXECUTE button 1203, the Web browser of the PC 101 transmits a copy/move request to the document management system 103.

Thus, in a step S1500 in FIG. 15, a copy/move request receiving unit 303 in the document management system 103 receives data including the request, request type, an identifier of a destination folder to which to copy/move the PDF document data, and an identifier of the PDF document data to be copied/moved.

In step S1501, the copy/move request receiving unit 303 detects the identifier of the destination folder and the identifier of the PDF document data from the received data and stores these identifiers in the RAM 202. The copy/move request receiving unit 303 then transfers the process to a document copying/moving unit 312. In accordance with the identifier, stored in the RAM 202, of the PDF document, the document copying/moving unit 312 reads the property of the PDF document data from the document property storage unit 317 and determines whether the PDF document data to be copied/moved is encrypted PDF document data or not.

If it is determined that encrypted PDF document data is to be copied/moved, the processing flow proceeds to step S1503, but otherwise the processing flow proceeds to step S1502.

In the case where the processing flow proceeds to step S1502, the document copying/moving unit 312 reads the PDF document data from the document/folder information storage unit 316 in accordance with the identifier, stored in the RAM 202, of the PDF document data. In accordance with the identifier, stored in the RAM 202, of the destination folder to which to move the document data, the document copying/moving unit 312 writes, in the document/folder information storage unit 316, the data requested to be copied/moved. The document copying/moving unit 312 then writes, in the document property storage unit 317, the property of the document to be copied/moved.

On the other hand, in the case where the processing flow proceeds to step S1503, in accordance with the identifier, stored in the RAM 202, of the PDF document data, the document copying/moving unit 312 acquires information associated with users allowed to access the PDF document data from the user information storage unit 319 and access right information storage unit 320. Note that the information associated with users allowed to access the PDF document data is, in this case, information associated with users allowed to access the source folder in which the PDF document data subjected to the copying/moving process is stored. The document copying/moving unit 312 stores, in the RAM 202, the acquired information associated with users allowed to access the source folder. In accordance with the identifier, stored in the RAM 202, of the destination folder to which to copy/move the PDF document data, the document copying/moving unit 312 acquires information associated with users allowed to access the destination folder to which to copy/move the PDF document data from the user information storage unit 319 and access right information storage unit 320. The document copying/moving unit 312 stores, in the RAM 202, the acquired information associated with users allowed to access the destination folder to which to copy/move the PDF document data. The document copying/moving unit 312 then compares the information stored in the RAM 202 between the information associated with users allowed to access documents in the source folder and the information associated with users allowed to access the destination folder to which to copy/move the PDF document data, and document copying/moving unit 312 determines whether the user information is identical.

If it is determined that the users allowed to access the destination folder are the same as the users allowed to access the source folder, the processing flow proceeds to step S1506, but otherwise the processing flow proceeds to step S1504.

Thus, in the present embodiment, as described above, an example of a third determination unit is implemented by step S1503. Furthermore, an example of a second management unit is implemented by storing information identifying users allowed to access PDF document data in the user information storage unit 319 and the access right information storage unit 320.

In step S1504, in accordance with the identifier, stored in the RAM 202, of the PDF document data, the document copying/moving unit 312 acquires information associated with the producer of the PDF document data from the document property storage unit 317, and the stores the acquired information in the RAM 202. The document copying/moving unit 312 then determines whether the information associated with the user who issued the copy/move request is the same as the information associated with the producer of the PDF document data.

If it is determined that the request issuer is the producer of the PDF document data, the processing flow proceeds to step S1506, but otherwise the processing flow proceeds to step S1505.

Thus, in the present embodiment, as described above, an example of a second determination unit is implemented by step S1504, and an example of a management unit is implemented by storing the information associated with the produce of the PDF document data in the document property storage unit 317.

In the case where the processing flow proceeds to step S1505, the document copying/moving unit 312 reads the data of the encrypted PDF document and the property information of the encrypted PDF document data from the document/folder information storage unit 316 and the document property storage unit 317, and performs the copying/moving process. The document copying/moving unit 312 then stores data necessary as a result of the copying/moving process in the document/folder information storage unit 316 and the document property storage unit 317.

In a case where the process performed on the PDF document data is moving, the encrypted PDF document data, the decrypted PDF document data, and the image-for-view data in the source folder are deleted from the document/folder information storage unit 316, the document property storage unit 317, and the image-for-view storage unit 318.

On the other hand, in the case where the processing flow proceeds to step S1506, the document copying/moving unit 312 reads the encrypted PDF document data, the decrypted PDF document data, and the property information of the PDF document data from the document/folder information storage unit 316 and the document property storage unit 317. The document copying/moving unit 312 reads the image for view corresponding to the PDF document data from the image-for-view storage unit 318, and performs the copying/moving process. The document copying/moving unit 312 then stores data necessary as a result of the copying/moving process in the document/folder information storage unit 316, the document property storage unit 317, and the image-for-view storage unit 318.

Thus, in the present embodiment, as described above, an example of a processing unit is implemented by steps S1505 and S1506.

Although in the example described above, one piece of PDF document data is copied or moved, a plurality of pieces of PDF document data may be copied or moved at a time.

Next, the process is described for the case in which the right to access a folder, in which encrypted PDF document data and decrypted PDF document data are stored, is changed from that assigned when the encrypted PDF document data and decrypted PDF document data were originally registered.

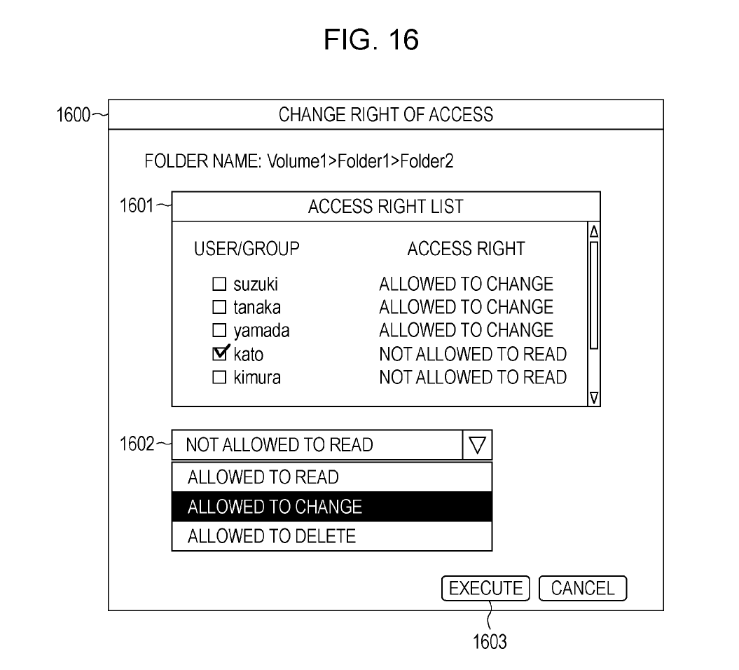

FIG. 16 illustrates an example of a window for changing a right to access folder. This window 1600 for changing the access right is displayed on the screen of the display of the PC 101 when a folder access right is changed.

In the example shown in FIG. 16, access rights are changed via the window 1600 for changing the access right such that a current status in which three users (suzuki, tanaka, and yamada) have a right to change documents is changed into a state in which a right to change documents is additionally given to a user (kato).

In this case, the above-described change can cause a change in the access right associated with the PDF document data registered by the producer (i.e., user “yamada”) of this PDF document data. More specifically, for example, the access right may change from the initial state in which three users including the producer of the PDF document data are allowed to access the PDF document data without having to input the password. In the present embodiment, to avoid the above problem, if an increase occurs in the number of users having an access right as a result of a change in terms of access right to a folder in which decrypted PDF document data is stored, the document management system 103 performs the following process. That is, the document management system 103 temporarily changes the status of the decrypted PDF document data and that of the image-for-view data such that the PDF document data cannot be accessed unless a valid password is input. The document management system 103 then sends mail to the producer of the PDF document data of interest to notify that a change has occurred in the right to access the folder in which the decrypted PDF document corresponding to the PDF document data of interest is stored.

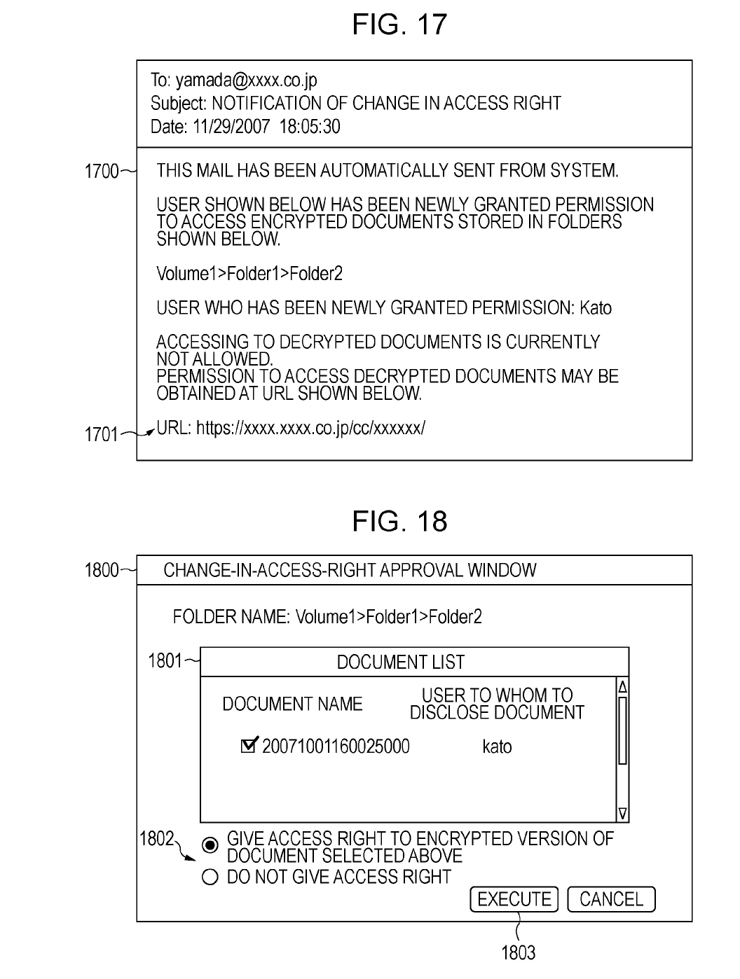

FIG. 17 illustrates an example of mail sent to a user (yamada in this example) who is a producer of PDF document data.

As shown in FIG. 17, URL 1701 is described in the mail 1700. If the user who is the producer of the PDF document data clicks the URL 1701, a window may be displayed for changing the access right into a state in which the PDF document data is allowed to be accessed without having to input a password.

FIG. 18 illustrates an example of an access right approval window. This access right approval window 1800 is displayed on the screen of the display of the PC 101 when a change occurs in a folder access right and the URL 1701 in the mail 1700 shown in FIG. 17 is clicked by a user who is a producer of PDF document data. This access right approval window 1800 is used by the producer of the PDF document data to give one or more selected users the right to access the PDF document data which has been temporarily brought in the state in which the PDF document data is inaccessible unless the valid password is input.

As shown in FIG. 18, in a document list displaying area 1801 of the access right approval window 1800, a list of decrypted PDF document data (document names) is displayed. A user (additional user) to whom an access right is additionally given as a result of a change in access right is also displayed in the document list displaying area 1801 so as to indicate what is going to change in terms of the access right compared with the initial state.

If the user (yamada) who is the producer of the PDF document data permits an increase in the number of users having a right to access the PDF document data as a result of the change in access right, the user (yamada) selects the PDF document data in the document list displaying area 1801 and then selects an approve button in an approve/disapprove selection part 1802. If the user (yamada) further clicks an EXECUTE button 1803, the encrypted PDF document data in the state in which accessing thereto is temporarily forbidden is brought into a state in which accessing is allowed. In this state, a user (kato) is also allowed to view the content of the PDF document data without having to input a password.

On the other hand, when the user (yamada) does not want to permit the increase in the number of users having the access right as a result of the change in access right, the user (yamada) selects a disapprove button in the approve/disapprove selection part 1802 and clicks the EXECUTE button 1803. In response, the decrypted PDF document data and the image-for-view data corresponding to the PDF document data selected in the document list displaying area 1801 are deleted. In this case, even users having the right to the folder before the change in the folder access right are brought into a state in which the PDF document data in the folder cannot be accessed unless the valid password is input.

The mail 1700 is sent and the access right approval window 1800 is displayed in the case where an administrator other than the producer (yamada) of PDF document data has changed the access right associated with this PDF document. In a case where the user (yamada) who is the producer of the PDF document data has a right as an administrator and thus has a right to change the access right associated with the PDF document data, the notification of the change in the access right (mail 1700) may not be sent. In this case, a confirmation window is displayed on the display of the PC 101 when a change occurs in access right, and the access right may be given to additional users according to the confirmation.

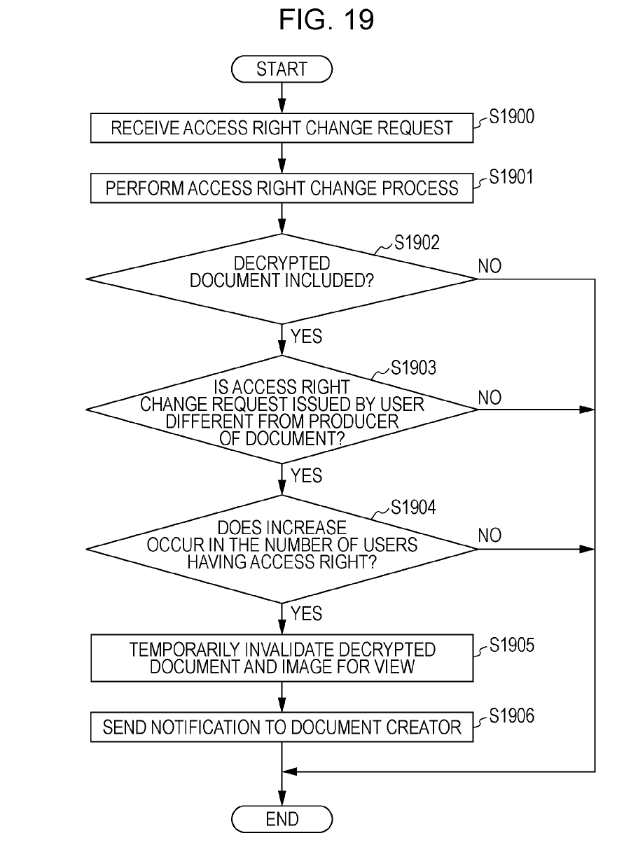

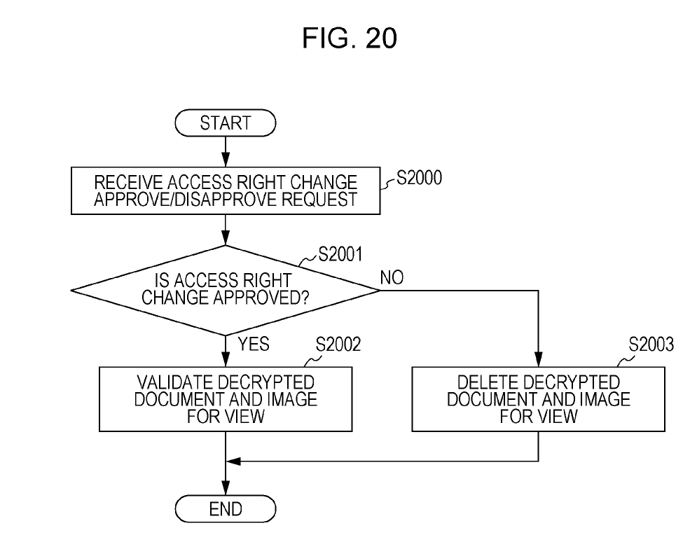

Next, referring to flow charts shown in FIGS. 19 and 20, more detailed explanations are given below as to an example of a process performed by the document management system 103 to change a right to access a particular folder and an example of a process performed by the document management system 103 to approve/disapprove a change in right to access a particular document resulting from the change in the right to access this particular folder.

FIG. 19 is a flow chart showing an example of a process performed by the document management system 103 to change a right to access a folder.

In the window 1600 for changing the access right shown in FIG. 16, if an administrative user (administrator) having a right to manage a folder (folder #2 in the present example) issues a command to change a right to access this folder (folder #2), then the Web browser of the PC 101 transmits an access right change request and data indicating details of the change in access right to the document management system 103.

In step S1900, if an access right change request receiving unit 304 receives the access right change request and data indicating the details of the change in access right, the access right change request receiving unit 304 stores the data indicating the details of the change in access right in the RAM 202. The access right change request receiving unit 304 then calls an access right changing unit 313 and transfers the process to the access right changing unit 313.

Next, in step S1901, the access right changing unit 313 reads the data indicating the details of change in access right from the RAM 202 and performs the specified change in access right. The access right changing unit 313 stores the result in the access right information storage unit 320.

Next, in step S1902, the access right changing unit 313 acquires an identifier identifying a folder of interest to be subjected to the change of access right from the data stored in the RAM 202. According to the identifier identifying the folder of interest, the access right changing unit 313 reads information associated with PDF document data belonging to the folder of interest from the document/folder information storage unit 316. Furthermore, based on the read information associated with the PDF document data, the access right changing unit 313 determines whether there is encrypted PDF document data having decrypted PDF document data associated therewith in the folder of interest subjected to the change of access right. That is, the access right changing unit 313 determines whether there is decrypted PDF document data in the folder of interest subjected to the change of access right.

If it is determined that there is no decrypted PDF document data in the folder of interest, the process of the flow chart shown in FIG. 19 is ended, but otherwise the processing flow proceeds to step S1903.

In step S1903, the access right changing unit 313 acquires the information associated with the encrypted PDF document data corresponding to the decrypted PDF document data determined in step S1902 as being included in the folder of interest from the document/folder information storage unit 316. The access right changing unit 313 then determines whether the access right change request was issued by a user different from the producer of the encrypted PDF document data.

If it is determined that the issuer of the access right change request is the producer of the encrypted PDF document data, the process of the flow chart shown in FIG. 19 is ended, but otherwise the processing flow proceeds to step S1904.

In step S1904, the access right changing unit 313 reads the data from the RAM 202 in terms of the details of the change of the access right. Based on the data indicating the details of the change of access right, the access right changing unit 313 determines whether the change of access right to the folder of interest will lead to additionally give a new user the access right to the folder of interest.

If it is determined that the change of access right will not additionally give any new user the access right to the folder of interest, the process of the flow chart shown in FIG. 19 is ended, but otherwise the processing flow proceeds to step S1905.

In step S1905, the access right changing unit 313 transfers the process to an encrypted document management unit 315. The encrypted document management unit 315 changes the property information stored in the document property storage unit 317 such that the decrypted PDF document data and the image-for-view data included in the folder of interest are invalidated.

Thus, in the present embodiment, as described above, an example of an invalidation unit is implemented by step S1905.

Next, in step S1906, based on the information read from the document property storage unit 317 and the user information storage unit 319, an access right change notifying unit 314 acquires the information associated with the producer of the PDF document data whose property information has been changed in step S1905, and the access right change notifying unit 314 stores the acquired property information in the RAM 202. The access right change notifying unit 314 then transmits mail 1700, via the mail server 104, to an mail address included in the information associated with the producer stored in the RAM 202.

Thus, in the present embodiment, as described above, an example of a notification unit is implemented by step S1906.

FIG. 20 is a flow chart illustrating an example of a process performed in the document management system 103 to approve or disapprove the change in access right to a document that will occur as a result of the change in access right to the folder made in the process of the flow chart shown in FIG. 19.

If the user who is the producer of the PDF document selects the approve button in the approve/disapprove selection part 1802 of the access right approval window 1800 shown in FIG. 18 and further clicks the EXECUTE button 1803, then the Web browser of the PC 101 transmits an access right change request to the document management system 103.

In step S2000, if an access right approval request receiving unit 305 in the document management system 103 receives the access right approval/disapproval request, the access right approval request receiving unit 305 detects the identifier of the PDF document data and data indicating a process specified to be performed from the request and stores the detected identifier and data in the RAM 202.

In step S2001, based on the data indicating the specified process stored in the RAM 202, the access right approval request receiving unit 305 determines whether to approve the changed status in the access right (whether to additionally give the new user(s) the access right to the encrypted PDF document.

If it is determined that the change status in the access right should be approved, the processing flow proceeds to step S2002, but otherwise the processing flow proceeds to step S2003.

In the case where the processing flow proceeds to step S2003 because approval was denied as to the access right to the PDF document data included in the folder of interest whose access right has been changed, the encrypted document management unit 315 performs the following process. That is, the encrypted document management unit 315 deletes the corresponding decrypted PDF document data and image-for-view data from the document/folder information storage unit 316 and the image-for-view storage unit 318, and accordingly rewrites the associated property information stored in the document property storage unit 317.

In the case where the processing flow proceeds to step S2002, the encrypted document management unit 315 rewrites the property information in the document property storage unit 317 so as to re-validate the temporarily invalidated decrypted PDF document data and image-for-view data included in the folder of interest that has been subjected to the change of access right.

Thus, in the present embodiment, as described above, an example of a validation unit is implemented by step S2002.

In the present embodiment, as described above, when a valid password is input, decrypted document data is produced by decrypting the encrypted document data included in a folder that has been set in terms of access right. Furthermore, image-for-view data corresponding to the encrypted document is produced, and the decrypted document data and the image-for-view data are stored in a correlated manner in the folder. If a request to view a document in the folder is issued by a user having the right to access the folder, the image for view is displayed on a terminal of the issuer. In the case where a request to acquire a document in the folder is issued by a user having the right to access the folder, a determination is made as to whether the acquisition request is for storing the document or for printing the document. If it is determined that the acquisition request is for printing, corresponding decrypted document data is transmitted to a terminal of the issuer. On the other hand, if the acquisition request is for storing the document, corresponding encrypted document data is transmitted to the terminal of the issuer.

Thus, a user having the right to access the folder is allowed to view and print documents in the folder without having to input a password. When a document is stored (downloaded) in a terminal of a user, the document is dealt with in the form of an encrypted file, and it is necessary to input a valid password. However, inputting of the password is not necessary as long as the document is viewed or printed. Even if an unexpected distribution of the file occurs, it is possible to maintain secrecy because the file is in the encrypted form.

In the present embodiment, as described above, when a document is copied or moved from a source folder to a destination folder by a user who has the right to access the source folder but who is not the producer of the document, if the access right associated with destination folder is differently set from that associated with the source folder, only encrypted document data is copied or moved. Thus, after a document is registered, if the document is copied or moved by a user who is not the producer of the document, the copied or moved document is set to be inaccessible unless a valid password is input. This ensures that the document is protected from unauthorized access.

In the present embodiment, as described above, if a change in access right to a folder causes an additional new user to obtain the access right to the folder, this fact is notified to a producer of a document located in this folder, and usage of decrypted document data and image-for-view data in this folder is disabled until the producer approves the change in the status of the access right. This makes it possible to control the status of the access right according to the intention of the producer of the document.

In the embodiment described above, by way of example, the explanation has been given for the case in which the access right is set for a folder which is an example of a storage area. Note that the present embodiment may also be applied to a case where an access right is set for a document, a cabinet, a local disk, etc.

Note that a document registration request receiving unit 302 and a document registration unit 311 shown in FIG. 3 do not have a contribution to the present embodiment but have a contribution to a second embodiment described below.

### Second Embodiment

Next, a second embodiment of the present invention is described below. In the first embodiment described above, by way of example, decryption is performed for encrypted documents which have already been registered in the document management system 103. In the second embodiment described below, a technique is disclosed for a case in which an encrypted document is newly registered in the document management system 103. More specifically, the present embodiment will be described for two cases. In a first case, when an encrypted document is registered, a password associated therewith is also registered. In a second case, when an encrypted document is registered, a decrypted document associated therewith is also registered. That is, the present embodiment is similar to the first embodiment except that there is an additional process performed when encrypted document data is registered. Thus, in the following explanation of the second embodiment, similar parts to those in the first embodiment are denoted by similar reference numerals used in FIGS. 1 to 20, and a further detailed explanation thereof is omitted. In the present embodiment, as with the first embodiment, it is assumed that documents dealt with are in the PDF format.

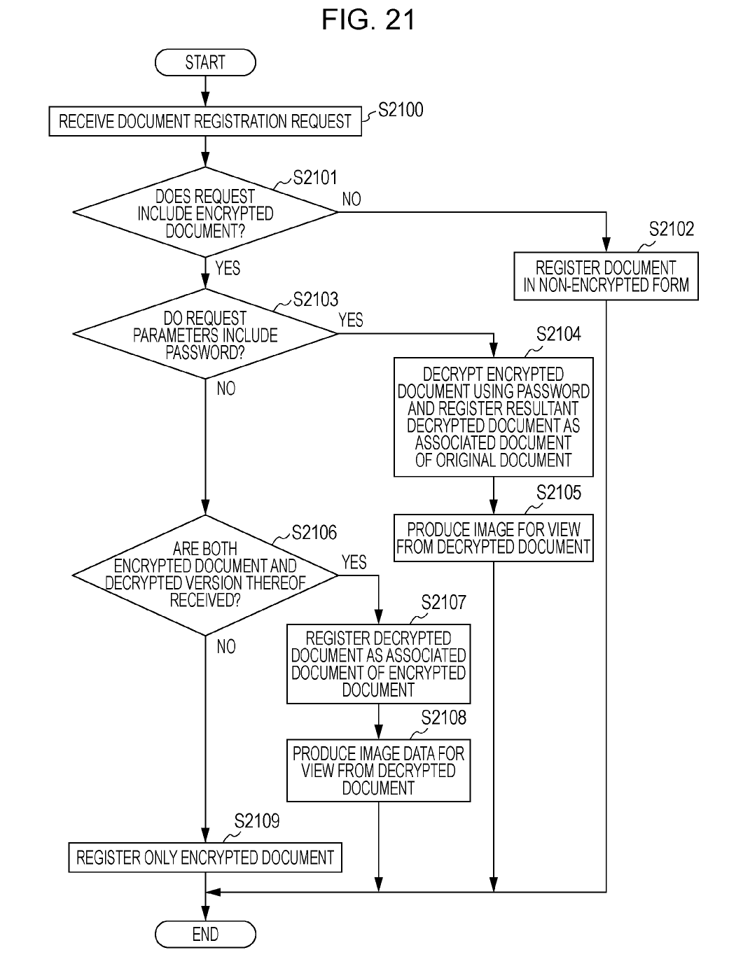

FIG. 21 is a flow chart illustrating an example of a process performed in the document management system 103 in response to receiving a document registration request.

When a registration of encrypted PDF document data is requested, transmission of PDF document data to the document management system 103 can occur in the following four cases. In a first case, only normal PDF document data is transmitted. In a second case, only encrypted PDF document data is transmitted. In a third case, encrypted PDF document data is transmitted together with a password for use in decrypting the encrypted PDF document data. In a fourth case, both encrypted PDF document data and decrypted PDF document data obtained by decrypting the encrypted PDF document data are transmitted.

In step S2100 in FIG. 21, if the document registration request receiving unit 302 of the document management system 103 receives a document registration request, the document registration request receiving unit 302 stores received data included in the document registration request in the RAM 202. The document registration request receiving unit 302 then stores an actual file included in the document registration request in a temporary storage area of the HDD 209, and the document registration request receiving unit 302 transfers the process to the document registration unit 311.

Next, in step S2101, the document registration unit 311 reads details of the received data stored in the RAM 202 and also reads the actual file (PDF document data) stored in the temporary storage area of the HDD 209. The document registration unit 311 then determines based on the read information whether PDF document data requested to be registered includes encrypted PDF document data.

If it is determined that the PDF document data requested to be registered includes no encrypted PDF document data, the processing flow proceeds to step S2102 but otherwise the processing flow proceeds to step S2103.

In the case where the processing flow proceeds to step S2102, the document registration unit 311 reads the PDF document data from the HDD 209 and stores it in the document/folder information storage unit 316. The document registration unit 311 then reads necessary data from the RAM 202 and describes the property information of the PDF document data in the document property storage unit 317 so as to indicate that the PDF document data is a normal document.

On the other hand, in the case where the processing flow proceeds to step S2103, the document registration unit 311 reads the received data stored in the RAM 202 and determines whether the received data includes a password used in the encryption of the document.

If it is determined that the received data stored in the RAM 202 includes the password, the processing flow proceeds to step S2104, but otherwise the processing flow proceeds to step S2106.

In the case where the processing flow proceeds to step S2104, the document registration unit 311 reads the PDF document data (encrypted PDF document data) from the temporary storage area of the HDD 209 and stores it in the document/folder information storage unit 316. The document registration unit 311 then reads necessary received data from the RAM 202 and describes the property information of the PDF document data in the document property storage unit 317. Furthermore, the document registration unit 311 reads the password for decrypting the encrypted PDF document data from the RAM 202, and the document registration unit 311 transfers the process to the document decryption unit 306.

The document decryption unit 306 reads the encrypted PDF document data from the temporary storage area of the HDD 209 and decrypts the encrypted PDF document data using the password. The document decryption unit 306 stores the resultant decrypted PDF document data in the temporary storage area of the HDD 209.

The document registration unit 311 reads the decrypted PDF document data from the temporary storage area of the HDD 209 and stores this decrypted PDF document data as an associated document of the encrypted PDF document data in the document/folder information storage unit 316. The document registration unit 311 then describes property information in the document property storage unit 317 to indicate that the data stored in the document/folder information storage unit 316 includes the decrypted PDF document data. Thereafter, the document registration unit 311 transfers the process to the image-for-view data producing unit 310.

Thus, in the present embodiment, as described above, an example of a decryption unit and an example of a storage unit are implemented by step S2104.

Next, in step S2105, the image-for-view data producing unit 310 reads the decrypted PDF document data from the temporary storage area of the HDD 209 and produces image-for-view data. Thereafter, the image-for-view data producing unit 310 stores the resultant produced image-for-view data in the image-for-view storage unit 318 and describes property information associated with the image-for-view data in the document property storage unit 317.

Thus, in the present embodiment, as described above, an example of a producing unit is implemented by step S2105.

In the case where the received data stored in the RAM 202 includes no password, the processing flow proceeds to step S2106. In step S2106, the document registration unit 311 reads the received data from the RAM 202 and determines whether it is requested by the document registration request to register a pair of encrypted PDF document data and decrypted PDF document data.

If it is determined that it is requested by the document registration request to register a pair of encrypted PDF document data and decrypted PDF document data, the processing flow proceeds to step S2107. On the other hand, if the request of the document registration request is not to register a pair of encrypted PDF document data and decrypted PDF document data but to register only encrypted PDF document data, the processing flow proceeds to step S2109.

In step S2107, the document registration unit 311 reads the received data from the RAM 202. Based on the read data, the document registration unit 311 reads PDF document data (encrypted PDF document data and decrypted PDF document data) to be registered from the temporary storage area of the HDD 209. The document registration unit 311 stores the encrypted PDF document data in the document/folder information storage unit 316 and stores the decrypted PDF document data as an associated document of the encrypted PDF document data in the document/folder information storage unit 316. The document registration unit 311 describes information in the document property storage unit 317 to indicate that the encrypted PDF document data and the decrypted PDF document data are in the same pair.

Thus, in the present embodiment, as described above, an example of a storage unit is implemented by step S2107.

Next, in step S2108, the image-for-view data producing unit 310 reads the decrypted PDF document data from the temporary storage area of the HDD 209 and produces image-for-view data. The image-for-view data producing unit 310 stores the resultant produced image-for-view data in the image-for-view storage unit 318 and describes information associated with the image-for-view data in the document property storage unit 317.

Thus, in the present embodiment, as described above, an example of a producing unit is implemented by step S2108.

In the case where the request by the document registration request is to register only encrypted PDF document data, the processing flow proceeds to step S2109. In step S2109, the document registration unit 311 reads the encrypted PDF document data from the temporary storage area of the HDD 209 and stores it in the document/folder information storage unit 316. Furthermore, the document registration unit 311 reads necessary received data from the RAM 202 and describes, in the document property storage unit 317, property information of the PDF document stored in the document/folder information storage unit 316.

In the state in which the pair of the encrypted document and the decrypted document has been registered and the image for view has been produced in the above-described manner, a process such as copying or moving of the PDF document, imposing a restriction on access to the PDF document in response to an occurrence of a change in access right to the folder, etc., may be performed in a similar manner to the first embodiment described above.

In the present embodiment, by way of example, the explanation has been given for the case where one pair of an encrypted document and an associated password is registered, and for the case where one pair of an encrypted document and an associated decrypted document is registered. Note that a plurality of pairs may be processed (registered) at a time.

### Other Embodiments

Units of the document management system and steps of the document management method according to one of or a combination of the embodiments described above may be realized by executing a program stored in a RAM or a ROM of a computer. Note that such a program and a computer-readable storage medium in which the program is stored falls within the scope of the present invention.

The present invention may be embodied in many forms such as a system, an apparatus, a method, a program, a storage medium, etc. The present invention may be applied to a system including a plurality of devices or may be applied to an apparatus including only a single device.

The purpose of the present invention can also be realized by executing the following process. That is, a process in which a recording medium, in which a program code of a software that realizes the functions of the above-described embodiments is recorded, is supplied to the system or apparatus, and then a computer of the system or apparatus (such as CPU or MPU) reads out the program code stored in the recording medium. In such a case, the program code read out from the recording medium itself realizes the functions of the above-described embodiments, and the recording medium where the program code is stored as well as the program code are included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-193825 filed Jul. 28, 2008, which is hereby incorporated by reference herein in its entirety.

What is claimed is:

1. A document management system configured to manage encrypted document data encrypted using a password, comprising:
a storage unit configured to store the encrypted document data and decrypted document data obtained by decrypting the encrypted document data in a correlated manner in a storage area; and
a return unit configured to return document data such that when a request for access to document data stored in the storage area is issued by a user having a right to access the document data or the storage area in which the document data is stored, the return unit returns decrypted document data corresponding to the document data.

2. The document management system according to claim 1, further comprising a producing unit configured to produce image data based on the decrypted document data,
wherein the storage unit stores, in a storage medium in a correlated manner, the encrypted document data, decrypted document data obtained by decrypting the encrypted document data, and the image data produced based on the decrypted document data, and
when the return unit receives a request for document data from a user having the access right, the return unit returns image data corresponding to the requested document data.

3. The document management system according to claim 2, further comprising a determination unit configured to determine what is requested to be performed by a request issued by a user having the access right,
wherein the return unit returns data such that when the request from the user having the access right is to print document data, the return unit returns decrypted document data corresponding to the document data, when the request from the user having the access right is to view document data, the return unit returns image data produced based on the document data, and when the request from the user having the access right is to store document data, the return unit returns encrypted document data corresponding to the document data.

4. The document management system according to claim 1, further comprising:
a management unit configured to manage information associated with a producer of document data;
a second determination unit configured to, when a request to copy or move document data is issued, determine whether an issuer of the request is the producer of the document data; and
a processing unit configured to process document data such that if the second determination unit determines that the issuer of the request is the producer of the document data, then the processing unit copies or moves data correlated to the document data stored in the storage area in accordance with the request, but if the second determination unit determines that the issuer of the request is not the producer of the document data, then the processing unit copies or moves encrypted document data correlated to the document data stored in the storage area in accordance with the request.

5. The document management system according to claim 4, further comprising:
a second management unit configured to manage the access right; and
a third determination unit configured to, when a request to copy or move document data is issued, determine whether a user or users having a right to access the document data in a source storage area in which the document data requested to be copied or moved is located is the same as a user or users having a right to access document data in a destination storage area to which the document data is requested to be copied or moved,
wherein if the third determination unit determines that the user or users having the right to access the document data in the source storage area in which the document data requested to be copied or moved is located is not the same as the user or users having the right to access document data in the destination storage area to which the document data is requested to be copied or moved, then the second determination unit determines whether the issuer of the request is the producer of the document data,
while if the third determination unit determines that the user or users having the right to access the document data in the source storage area in which the document data requested to be copied or moved is located is the same as the user or users having the right to access document data in the destination storage area to which the document data is requested to be copied or moved, then, in accordance with the request, the processing unit copies or moves data correlated to each other in the source storage area in which the document data requested to be copied or moved is located.

6. The document management system according to claim 1, further comprising:
an invalidation unit configured to, if a request to change the access right is issued, temporarily invalidate data correlated to encrypted document data in a storage area requested to be changed in terms of access right thereto;
a notification unit configured to notify a producer of document data corresponding to the invalidated data that the data has been invalidated by the invalidation unit; and
a validation unit configured to, if approval is given by the producer to whom the notification was sent, validate the data invalidated by the invalidation unit.

7. The document management system according to claim 1, further comprising:
an acquisition unit configured to acquire encrypted document data and a password for use in decrypting of the encrypted document data from an external apparatus; and
a decryption unit configured to decrypt the encrypted document data using the password acquired by the acquisition unit,
wherein the storage unit stores the encrypted document data acquired by the acquisition unit and the decrypted document data decrypted by the decryption unit in a correlated manner in a storage area.

8. The document management system according to claim 1, further comprising an acquisition unit configured to acquire the encrypted document data and decrypted document data obtained by decrypting the encrypted document data from an external apparatus,
wherein the storage unit stores, in a storage area, the encrypted document data and the decrypted document data acquired by the acquisition unit.

9. A document management method for managing encrypted document data encrypted using a password, comprising:
storing the encrypted document data and decrypted document data obtained by decrypting the encrypted document data in a correlated manner in a storage area; and
returning document data such that when a request for access to document data stored in the storage area is issued by a user having a right to access the document data or the storage area in which the document data is stored, decrypted document data corresponding to the document data is returned.

10. A computer-readable storage medium including a program stored therein for executing a document management method for managing encrypted document data encrypted using a password, document management method comprising:
storing the encrypted document data and decrypted document data obtained by decrypting the encrypted document data in a correlated manner in a storage area; and
returning document data such that when a request for access to document data stored in the storage area is issued by a user having a right to access the document data or the storage area in which the document data is stored, a command to return decrypted document data corresponding to the document data is issued.
